(19) United States
(12) Patent Application Publication
(10) Pub. No.: US 2005/0115622 A1
(43) Pub. Date: Jun. 2, 2005

(54) Collapsible flexible pipe and method of manufacturing same

(75) Inventors: Peter George Bennett, Morpeth (GB); Justin Tuohy, Kiloolgan (IE)

Correspondence Address: KLARQUIST SPARKMAN, LLP, 16th FLOOR WORLD TRADE CENTER, 121 W, SALMON STREET, PORTLAND, OR, 97204, US

(73) Assignee: Wellstream International Limited, London (GB)

(21) Appl. No.: 10/706,784

(22) Filed: Nov. 12, 2003

Related U.S. Application Data
(60) Provisional application No. 60/426,174, filed on Nov. 13, 2002.

(51) Int. Cl. F16L 11/00

(52) U.S. Cl. 138/119; 138/110; 138/177

(57) ABSTRACT

A flexible pipe and a method of manufacturing same according to which the pipe is formed by at least one layer, and an insert disposed in the layer and adapted to limit the strain on the layer when the pipe collapses.

### CROSS-REFERENCE

This application relates to, and claims priority of, co-pending provisional application No. 60/426,174, filed Nov. 13, 2002.

### BACKGROUND

Flexible pipes currently used in offshore oil and gas fields for the transport of fluids underwater between the subsea wellhead and the surface facilities are designed to retain a circular cross-section when subject to external hydrostatic pressure. This is usually achieved by the inclusion of metallic layers that extend around and support a polymer fluid barrier. The metallic layers are usually relatively large and heavy so that they do not deflect significantly under the collapse force. However, for deep water applications, the strength and the weight of the metallic layers required to resist collapse becomes a limiting factor in flexible pipe design.

### BRIEF DESCRIPTION OF THE DRAWINGS

FIGS. 1 and 2 are cross-sectional views of a flexible pipe according to an embodiment of the invention, showing the pipe in a non-collapsed and a collapsed condition, respectively.

FIGS. 3 and 4 are views, similar to FIGS. 1 and 2, depicting a flexible pipe according to another embodiment.

FIGS. 5 and 6 are views, similar to FIGS. 1 and 2, depicting a flexible pipe according to another embodiment.

FIGS. 7 and 8 are views, similar to FIGS. 1 and 2, depicting a flexible pipe according to another embodiment.

FIGS. 9 and 10 are views, similar to FIGS. 1 and 2, depicting a flexible pipe according to another embodiment.

FIGS. 11 and 12 are views similar to FIGS. 1 and 2 depicting a flexible pipe according to another embodiment.

### DETAILED DESCRIPTION

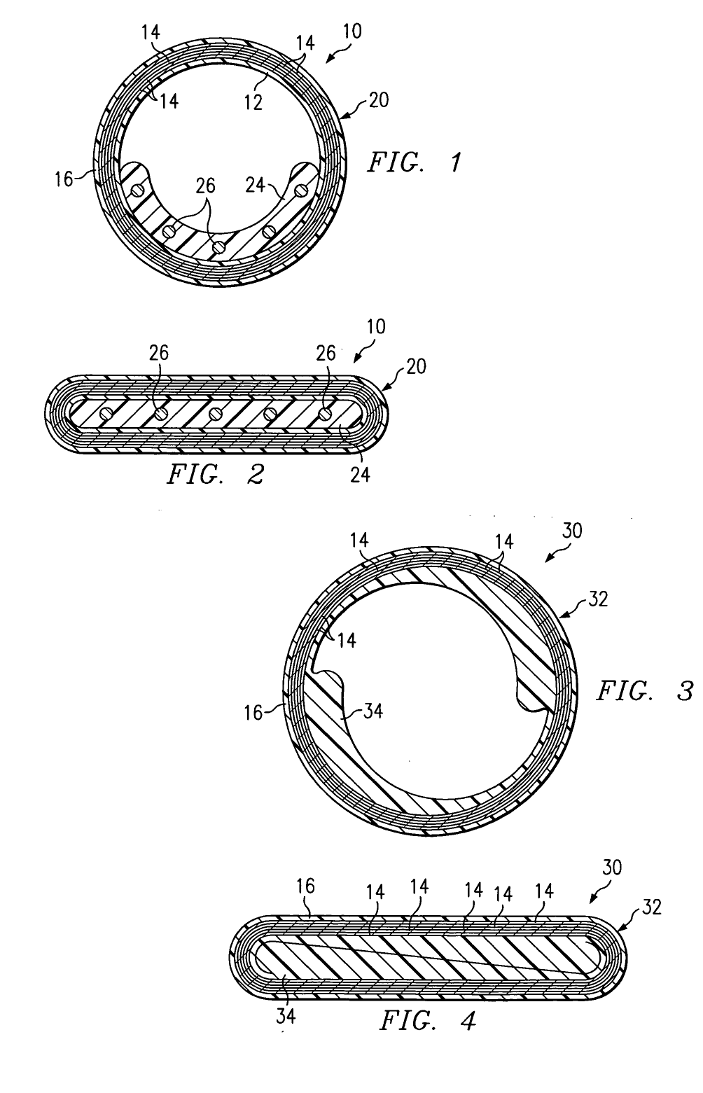

Referring to FIGS. 1 and 2 of the drawings, the reference numeral 10 refers, in general, to a pipe according to an embodiment of the invention which is adapted to receive a fluid at one end for the purposes of transporting the fluid. The pipe 10 is formed by an inner tubular layer 12, of a plastic, or polymeric material, for containing fluid and for serving as a liner/barrier. A series (in the example shown, five) of reinforcing layers 14 extend around the layer 12. The layers 14 can be in the form of helically wound or braided aramid, carbon and/or steel fibers and can be wrapped around the layer 12 to resist the internal pressure forces in the pipe 10.

An outer tubular layer 16, also of a plastic, or polymeric material, extends around the outermost reinforcing layer 14 to serve as a shield to protect the layers 14 from the external environment. The inner layer 12 and the outer layer 16 can be formed by a plastic, or polymeric material. The layers 12,14 and 16 form a tubular assembly, shown in general by the reference numeral 20.

An insert 24, having an arcuate cross-section, is disposed in the tubular assembly 20 in a coaxial relationship, with the insert normally conforming to the corresponding inner surface of the inner layer 12 in an abutting relationship, for the entire length of the inner layer. The insert 24 can be made from thermal plastic or thermal-set material, such as a nylon or rubber-like material, so that it has appropriate flexibility to conform to the shape of the assembly 20, which is tubular when the pipe is internally pressurized (FIG. 1) and flat when the pipe is externally pressurized (FIG. 2).

A series (in the example shown, five) of axially-extending, angularly-spaced, parallel, steel, or fiber, solid cylindrical reinforcing members 26 are embedded in the insert 24 and extend for the length of the insert.

The insert 24 extends angularly for approximately one-half the internal diameter of the tubular assembly 20, or for approximately 180 degrees. In this context, the outer surface of the insert 24 is substantially equal to the inner circumferential surface of the layer 12. Therefore, when the tubular assembly 20 is flattened as shown in FIG. 2 under conditions to be described, the insert 24 fully supports the tubular assembly in the flat condition while limiting the strain in the structural layers 12, 14 and 16 at the longitudinal fold. The pipe 10 thus possesses sufficient strength and integrity to withstand the internal pressure of the fluid being transported, yet has the flexibility to collapse under external pressure with limited strain on the tubular assembly 20.

A pipe according to the embodiment of FIGS. 3 and 4 is referred to, in general, by the reference numeral 30 and includes a tubular assembly 32 which is identical to the tubular assembly 20 of the embodiment of FIGS. 1 and 2, but for the fact that the inner tubular layer 12 is eliminated and the insert 24 of the latter embodiment have been replaced with an insert 34. The insert 34 extends within the tubular assembly 32 in a coaxial relationship, with the innermost layer of the series of layers 14 extending around the insert 34 in an abutting relationship for the entire length of the tubular assembly.

The insert 34 is fabricated from a material, such as thermal plastic or thermal-set material which can be in the form of nylon or rubber-like material. Thus, the insert 34 has appropriate flexibility to conform to the shape of the assembly 32, which is tubular when the pipe 30 is internally pressurized (FIG. 3) and flat when the pipe is externally pressurized (FIG. 4).

As shown in FIG. 3, the inner diameter of the insert 34 varies around the inner circumference of the insert from two diametrically opposed areas of minimum diameter to two diametrically opposed areas of maximum diameter. These changes in diameters of the layer/insert 34 are gradual from the minimum to the maximum diameters, and the medium thickness of the layer/insert 34 is substantially equal to the thickness of the tubular assembly 32.

Therefore, when the pipe 30 collapses to the position shown in FIG. 4, the upper half of the insert 34, as viewed in FIG. 3, nests in the lower half of the insert, as shown in FIG. 4 to enable the nested inserts to attain a substantially flat configuration. This limits the strain in the layers 14 and 16 of the tubular assembly 32 at the longitudinal fold of the pipe 30.

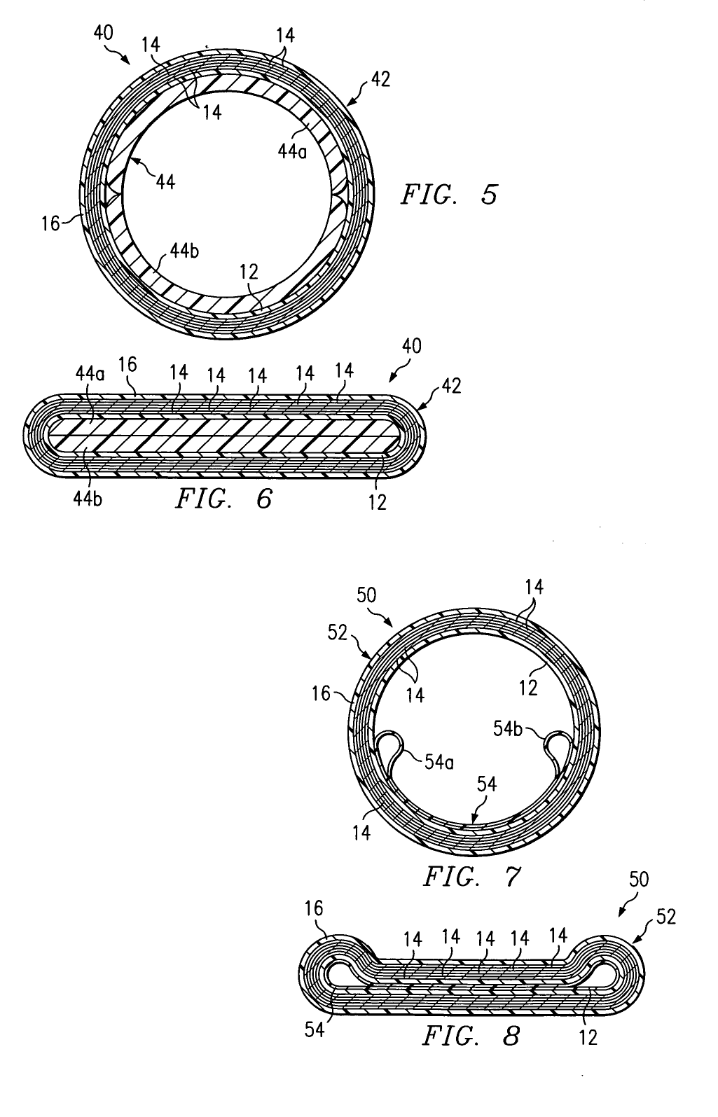

FIGS. 5 and 6 depict another embodiment of a pipe shown, in general, by the reference numeral 40 which includes a tubular assembly 42 which is identical to the tubular assembly 20 of the embodiment of FIGS. 1 and 2. An insert 44 extends within the tubular assembly 42 in a coaxial relationship, with the innermost layer of the series of layers 14 (FIG. 1) extending around the insert 44 in an abutting relationship for the entire length of the tube.

The insert 44 is fabricated from a material, such as thermal plastic or thermal-set material, which can be in the form of nylon or rubber-like material. Thus, the insert 44 has appropriate flexibility to conform to the shape of the assembly 42, which is tubular when the pipe 40 is internally pressurized (FIG. 5) and flat when the pipe is externally pressurized (FIG. 6).

The insert 44 consists of two arcuate sections 44a and 44b, each of which extends for approximately 180 degrees. The corresponding ends of the sections 44a and 44b engage each other in an abutting, diametrically opposed, relationship in a manner to form articulations to permit pivotal movement between the engaging ends when the pipe 40 collapses in the same manner as discussed in the previous embodiment. Thus, when collapsed, the corresponding inner surfaces of the sections 44a and 44b engage so that the insert 44 and the pipe 40 attain a substantially flat configuration as shown in FIG. 6. The insert 44 thus limits the strain in the structural layers of the tubular assembly 42 at the longitudinal fold of the pipe 40. It is understood that the insert 44 may also serve as an insulating layer.

A pipe according to the embodiment of FIGS. 7 and 8 is referred to, in general, by the reference numeral 50 and includes a tubular assembly 52 which is identical to the tubular assembly 20 of the embodiment of FIGS. 1 and 2.

An insert 54 is disposed in the tubular assembly 52 and extends angularly for approximately one-half the internal diameter of the tubular assembly 52, or for approximately 180 degrees. The insert 54 is formed by a flexible metallic ply, or layer, normally having a circular cross section, but with approximately one half portion (the upper half portion as viewed in FIG. 7) being folded over the other half portion, to form a substantially arcuate configuration having enlarged side portions 54a and 54b.

The external surface of the above-mentioned other half portion of the insert 54 conforms to the corresponding inner surface of the tubular assembly 52 in an abutting relationship for the entire length of the pipe 50. Thus, when the pipe 50 collapses from its normal position shown in FIG. 7 to a collapsed position shown in FIG. 8, the enlarged side portions 54a and 54b control the radius of the longitudinal fold in the wall of the pipe. This limits the strain on the structural layers of the tubular assembly 52 at the longitudinal fold.

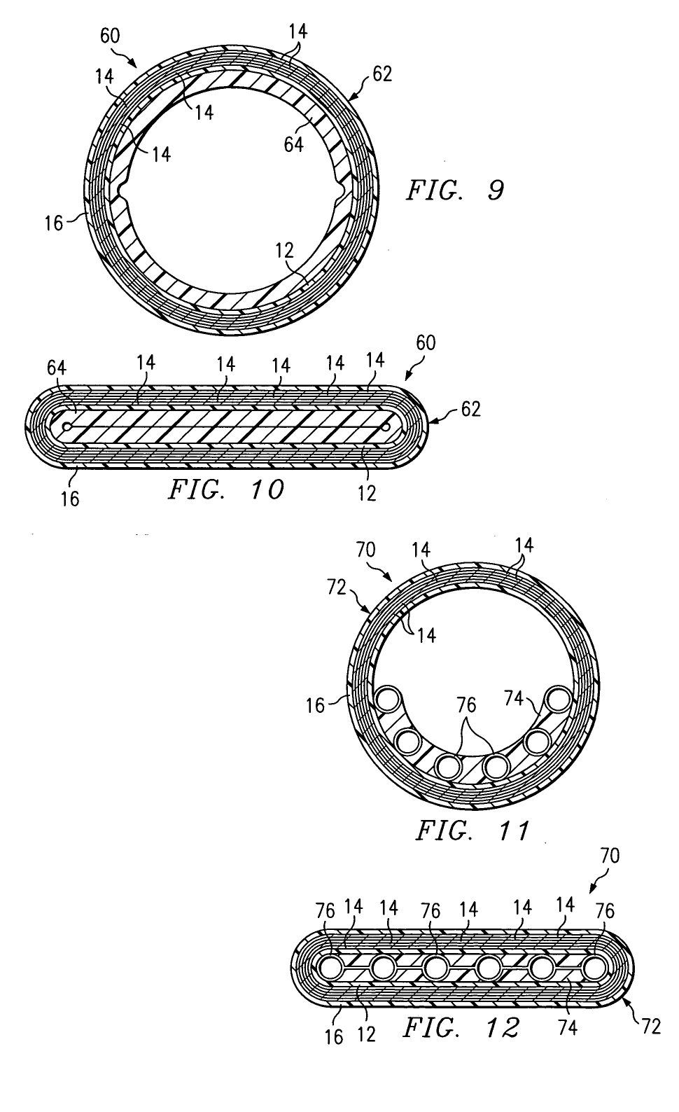

FIGS. 9 and 10 depict another embodiment which is shown, in general, by the reference numeral 60 and includes a tubular assembly 62 which is identical to the tubular assembly 20 of the embodiment of FIGS. 1 and 2. A tubular insert 64 extends within the tubular assembly 62 and is disposed in a coaxial relation to the assembly. The insert 64 is fabricated from a material, such as thermal plastic or thermal-set material, which can be in the form of nylon or rubber-like material. Thus, the insert 64 has appropriate flexibility to conform to the shape of the assembly 62, which is tubular when the pipe 60 is internally pressurized (FIG. 9) and flat when the pipe is externally pressurized (FIG. 10).

The circumference of the outer diameter of the insert 64 is constant and normally conforms to the corresponding inner surface of the tubular assembly 62 in an abutting relationship for the entire length of the tube.

The circumference of the inner diameter of the insert 64 is constant but for two diametrically opposed areas, each having a reduced cross-section, or groove. This enables the insert 64 to attain a substantially flat configuration when the pipe 60 collapses to the position shown in FIG. 10. In this collapsed condition, the insert 64 controls the radius of the longitudinal fold in the wall of the pipe 62 which limits the strain on the structural layers of the tubular assembly 62 at the longitudinal fold. It is understood that the insert 64 may also serve as an insulating layer.

A pipe according to the embodiment of FIGS. 11 and 12 is referred to, in general, by the reference numeral 70 and includes a tubular assembly 72 which is identical to the tubular assembly 20 of the embodiment of FIGS. 1 and 2. An arcuate insert 74 extends angularly within the tubular assembly 72 for approximately one-half the internal diameter of the tube 12, or for approximately 180 degrees. The insert 74 is fabricated from a material, such as thermal plastic or thermal-set material, which can be in the form of nylon or rubber-like material. Thus, the insert 74 has appropriate flexibility to conform to the shape of the assembly 72, which is tubular when the pipe 70 is internally pressurized (FIG. 11) and flat when the pipe is externally pressurized (FIG. 12).

A series (in the example shown, five) of spaced, parallel articulated cylindrical members 76 are embedded in the insert 74 and are joined together by extruded links 78 extending between the adjacent cylindrical members and connected thereto in any conventional manner. The member 76 can be in the form of tubes, solid cables, or the like. When collapsed, the pipe 70 attains a substantially flat configuration as shown in FIG. 12, and the insert 74 controls the radius of the longitudinal fold in the wall of the tubular assembly 72 and limits the strain on the structural layers of the tubular assembly at the longitudinal fold. Also, the above cylindrical members could serve as an umbilical that carries power and/or fluids for wellhead control, chemical injection or heating.

The pipes of the above embodiments possess sufficient strength and integrity to withstand the internal pressure of the fluid being transported, yet have the flexibility to collapse under external pressure. In each embodiment, the insert limits the strain in the wall structure of the pipe to a level which will not impair the structural integrity of the pipe when it is subjected to external pressure and is in a collapsed condition.

### Variations and Alternatives

1. Although each embodiment discussed above was referred to as a stand-alone pipe, each embodiment can also form a portion of a larger pipe having additional components, such as protective layers, anti-wear layers, and the like.

2. The above additional layers can also be placed between the reinforcing layers discussed above.

3. The particular material forming the layers and the inserts of the above embodiments can be varied within the scope of the invention as long as the above results are achieved.

4. The inserts could be integral with the inner layer of each tubular assembly.

5. The inserts may incorporate longitudinal members of steel or fiber to provide the required axial strength and to act as a ballast when required to stabilize the pipe on the sea bed.

6. The cross-sections of the arcuate inserts can extend for angular distances other than 180 degrees.

7. The insert 64 of the embodiment of FIGS. 9 and 10 can be replaced by a plain, non-grooved tubular insert, depending on the elastic properties of the insert material.

8. The specific composition of each of the layers forming the pipes 10, 30, 40 and 50 can be varied within the scope of the invention.

9. One or more of the layers forming the pipes 10, 30, 40 and 50 can be eliminated.

10. One or more of the layers forming the pipes 10, 30, 40 and 50 can be replaced by another layer of a different design.

11. Two or more of the layers 12, 14, and/or 16 can be provided.

12. Additional layers of a different design can be added to layers 12, 14 and/or 16.

13. The relative thicknesses of the layers forming the pipes 10, 30,40 and 50 are shown in the drawing only for the purpose of example, it being understood that these relative thicknesses can be varied within the scope of the invention.

14. The spatial references, such as “under”, “over”, “between”, “outer”, “inner” and “surrounding” are for the purpose of illustration only and do not limit the specific orientation or location of the layers described above.

15. The relative radial positions of the layers 12, 14, 16, 18, and 20 can be changed.

16. The size of the inner diameter of the inserts in the embodiment of FIGS. 3 and 4 can vary from only one minimum diameter to only one maximum diameter around the inner circumference of the insert.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

1. A flexible pipe comprising at least one layer, and an insert disposed in the layer, the cross-sectional area of the diameter of the insert varying around the circumference of the insert.

2. The pipe of claim 1 wherein the external surface of the arcuate portion of the insert conforms to the corresponding inner surface of the layer in an abutting relationship for the entire length of the pipe.

3. The pipe of claim 1 wherein the inner diameter of the insert varies from a minimum to a maximum around the inner circumference of the insert, with the minimum diameter being diametrically opposed to the maximum diameter.

4. The pipe of claim 3 wherein the inner diameter of the insert varies from two minimum diameters to two maximum diameters around the inner circumference of the insert.

5. The pipe of claim 4 wherein one of the minimum diameters is diametrically opposed to one of the maximum diameters, and wherein the other minimum diameter is diametrically opposed to the other maximum diameter.

6. The pipe of claim 4 wherein one half of the insert nests in the other half when the pipe collapses.

7. The pipe of claim 6 wherein the nested inserts attain a substantially flat configuration.

8. The pipe of claim 4 wherein the medium thickness of the insert is substantially equal to the thickness of the at least one layer.

9. The pipe of claim 1 wherein the insert limits the strain on the at least one layer when the pipe collapses.

10. The pipe of claim 1 wherein there is at least one reinforcing layer extending around the insert and one outer tubular layer extending around the outermost reinforcing layer.

11. A flexible pipe comprising at least one layer, and an insert disposed in the layer and comprising two arcuate sections, the corresponding ends of which engage each other in a manner to form articulations to permit pivotal movement between the engaging ends.

12. The pipe of claim 11 wherein the external surfaces of the arcuate sections conform to the corresponding inner surface of the layer in an abutting relationship for the entire length of the pipe.

13. The pipe of claim 11 wherein each of the insert sections extends for approximately 180 degrees.

14. The pipe of claim 11 wherein the engagement of two of the corresponding ends is diametrically opposed to the engagement of the other two corresponding ends.

15. The pipe of claim 11 wherein the corresponding inner surfaces of the sections engage when the pipe collapses so that the insert and the pipe attain a substantially flat configuration.

16. The pipe of claim 11 wherein the insert limits the strain on the at least one layer when the pipe collapses.

17. The pipe of claim 11 wherein there is at least one reinforcing layer extending around the insert and one outer tubular layer extending around the outermost reinforcing layer.

18. A flexible pipe comprising at least one layer, and an insert disposed in the layer, and formed by a flexible metallic ply having a circular cross section, approximately one half of the circular cross section of the ply being folded over its other half portion to form a substantially arcuate configuration having enlarged side portions.

19. The pipe of claim 18 wherein the external surface of the insert conforms to the corresponding inner surface of the layer in an abutting relationship for the entire length of the pipe.

20. The pipe of claim 18 wherein the enlarged side portions control the radius of the longitudinal fold in the wall of the pipe when the pipe collapses.

21. The pipe of claim 18 wherein the insert extends angularly for approximately one-half the internal diameter of the layer.

22. The pipe of claim 18 wherein the insert limits the strain on the at least one layer when the pipe collapses.

23. The pipe of claim 18 wherein there is at least one reinforcing layer extending around the insert and one outer tubular layer extending around the outermost reinforcing layer.

24. A pipe comprising at least one layer, and a tubular insert disposed in the layer, the circumference of the outer diameter of the insert being constant, and the circumference of the inner diameter of the insert being constant but for two diametrically opposed areas, each having a reduced cross-section.

25. The pipe of claim 24 wherein the external surface of the insert conforms to the corresponding inner surface of the layer in an abutting relationship for the entire length of the pipe.

26. The pipe of claim 24 wherein the reduced cross-sectional areas of the insert permit the insert to attain a substantially flat configuration when the pipe collapses.

27. The pipe of claim 25 wherein, in the collapsed condition of the pipe, the insert controls the radius of the longitudinal fold in the wall of the layer which limits the strain on the layer at the longitudinal fold.

28. The pipe of claim 24 wherein the reduced cross-sectional areas are diametrically opposed.

29. The pipe of claim 24 wherein the insert limits the strain on the at least one layer when the pipe collapses.

30. The pipe of claim 24 wherein there is at least one reinforcing layer extending around the insert and one outer tubular layer extending around the outermost reinforcing layer.

31. A pipe comprising at least one layer, an insert disposed in the layer, an arcuate insert disposed within the layer, and a plurality of articulated cylindrical members embedded in the insert.

32. The pipe of claim 31 wherein the cross-section of the insert extends for approximately one-half the internal diameter of the layer.

33. The pipe of claim 31 wherein the external surface of the insert conforms to the corresponding inner surface of the layer in an abutting relationship for the entire length of the pipe.

34. The pipe of claim 31 further comprising a link connecting adjacent cylindrical members.

35. The pipe of claim 31 wherein the cylindrical members are in the form of cables that transmit electrical power.

36. The pipe of claim 31, wherein the cylindrical members are in the form of tubular members that receive a fluid.

37. The pipe of claim 31 wherein, in the collapsed condition of the pipe, the pipe attains a substantially flat configuration.

38. The pipe of claim 37 wherein, in the collapsed condition of the pipe, the insert controls the radius of the longitudinal fold in the wall of the layer which limits the strain on the layer at the longitudinal fold.

39. The pipe of claim 31 wherein there is at least one reinforcing layer extending around the insert and one outer tubular layer extending around the outermost reinforcing layer.

40. A method of manufacturing a flexible pipe comprising disposing a flexible metallic ply having a circular cross section in an outer tubular layer, and folding over approximately one half of the circular cross section of the ply over its other half portion to form a substantially arcuate configuration having enlarged side portions.

41. The method of claim 40 further comprising conforming the external surface of the insert to corresponding inner surface of the layer in an abutting relationship for the entire length of the pipe.

42. The method claim 40 further comprising controlling the radius of the longitudinal fold in the wall of the pipe with the enlarged side portions when the pipe collapses.

43. The method of claim 40 further comprising limiting the strain on the at least one layer when the pipe collapses.
